(19) United States
(12) Patent Application Publication
(10) Pub. No.: US 2025/0384541 A1
(43) Pub. Date: Dec. 18, 2025

(54) Method for Performing Defect Inspection Using Multiple Domain Data

(71) Applicant: VAZIL Company Co., Ltd., Busan (KR)

(72) Inventors: Sungwon KIM, Daegu (KR); Bekhzod MUSTAFAEV, Busan (KR)

(21) Appl. No.: 19/216,742

(22) Filed: May 23, 2025

(30) Foreign Application Priority Data
Jun. 13, 2024 (KR) 10-2024-0076879

(51) Int. Cl. G06T 7/00

(52) U.S. Cl. CPC G06T 7/0004; G06T 2207/20081; G06T 2207/20084; G06T 2207/30108

(57) ABSTRACT

Disclosed is a method for performing defect inspection using a neural network model, which is performed by one or more processors of a computing device. The method may include: obtaining multiple input data having different domains; preprocessing first input data associated with a non-visual domain among the multiple input data; obtaining first training data based on second input data associated with a visual domain among the multiple input data, and the preprocessed first input data; and training a neural network model for performing defect inspection based on the first training data.

### CROSS-REFERENCE TO RELATED APPLICATIONS

This application claims priority to and the benefit of Korean Patent Application No. 10-2024-0076879, filed on Jun. 13, 2024, which is incorporated by reference herein in its entirety.

### TECHNICAL FIELD

The present disclosure relates to a method for performing defect inspection using multiple domain data, and more particularly, to a method for improving accuracy of defect inspection by performing preprocessing for multiple input data having different domains such as a non-visual domain and a visual domain, obtaining training data based on the input data for which the preprocessing is performed, and training a neural network model for performing defect inspection using the training data.

### BACKGROUND ART

There has been a tendency to rely on post-weld inspections, including visual inspections for surface defects (e.g., cracks, porosity) and non-destructiveness, in defect inspections of articles, such as conventional weld quality inspections. However, in the case of defect inspection relying on such post-weld inspection, defects can be identified only after the welding process is completed, and there is a problem that rework costs are high, the production schedule is delayed, and the overall cost increases. In addition, existing defect inspection of articles using deep learning focused on single modal data such as visual images, so there was a problem in that visual, thermal, and acoustic data for comprehensive quality evaluation could not be utilized together.

Therefore, there is a need for a method that can consolidate various sensor data (voltage, current and gas flow rate) with images to increase the accuracy of defect inspection while maintaining the parameters of the neural network model at an appropriate level to save resources.

On the other hand, the present disclosure has been derived at least based on the technical background described above, but the technical problem or object of the present disclosure is not limited to solving the problems or disadvantages described above. That is, the present disclosure may cover various technical issues related to the content to be described below, in addition to the technical issues discussed above.

### SUMMARY OF THE INVENTION

The present disclosure has been made in an effort to provide a method for performing defect inspection using multiple domain data, and more particularly, to improve accuracy of defect inspection by performing preprocessing for multiple input data having different domains such as a non-visual domain and a visual domain, obtaining training data based on the input data for which the preprocessing is performed, and training a neural network model for performing defect inspection using the training data.

Meanwhile, a technical object to be achieved by the present disclosure is not limited to the above-mentioned technical object, and various technical objects can be included within the scope which is apparent to those skilled in the art from contents to be described below.

An exemplary embodiment of the present disclosure provides a method performed by a computing device. The method may include: obtaining multiple input data having different domains; preprocessing first input data associated with a non-visual domain among the multiple input data; obtaining first training data based on second input data associated with a visual domain among the multiple input data, and the preprocessed first input data; and training a neural network model for performing defect inspection based on the first training data.

Alternatively, the multiple input data having different domains may include first input data associated with a non-visual domain and second input data associated with a visual domain, and the first input data associated with the non-visual domain may include time-series data.

Alternatively, the first input data associated with the non-visual domain may include sensor data of a process.

Alternatively, the sensor data of the process may include at least one of current sensor data; voltage sensor data; or gas flow sensor data.

Alternatively, the preprocessing of the first input data associated with the non-visual domain among the multiple input data may include: setting a time-series interval for the first input data; and preprocessing the first input data based on the set time-series interval.

Alternatively, the preprocessing of the first input data based on the set time-series interval may include transforming an interval included in the set time-series interval in the first input data into spectrogram data.

Alternatively, the preprocessing of the first input data based on the set time-series interval may further include preprocessing second input data associated with a visual domain among the multiple input data.

Alternatively, the preprocessing of the second input data associated with the visual domain among the multiple input data may include at least one of adjusting a size of the second input data associated with the visual domain; performing normalization for the second input data; or performing image augmentation for the second input data.

Alternatively, the obtaining of the first training data based on the second input data associated with the visual domain among the multiple input data, and the preprocessed first input data may include: obtaining a correct answer label corresponding to the preprocessed first input data and the second input data; and obtaining first training data based on the preprocessed first input data, the second input data, and the correct answer label.

Alternatively, the training of the neural network model for performing the defect inspection based on the first training data may include: obtaining a first feature by inputting first input data included in the first training data into the neural network model, and obtaining a second feature by inputting second input data included in the first training data into the neural network model; performing, by utilizing the neural network model, defect prediction based on the first feature and the second feature; and comparing the defect prediction result with the first training data to train the neural network model.

Alternatively, the obtaining of the first feature by inputting the first input data included in the first training data into the neural network model may include: obtaining first concatenated data based on first-first input data and first-second input data included in the first training data; and obtaining a first feature by inputting the first concatenated data into the neural network model.

Alternatively, the neural network model for performing the defect inspection may include an encoder for extracting a visual feature for input data.

Alternatively, the encoder for extracting the visual feature may include at least one of an extraction block for extracting features of different sizes for input data; a second module for identifying, among multiple features extracted from input data, a feature related to whether there is a defect; or a first module for identifying a feature region related to whether there is a defect among multiple features extracted for input data.

Another exemplary embodiment of the present disclosure provides a computer program stored in a computer-readable storage medium. When the computer program is executed by one or more processors, the computer program may allow the one or more processors to perform operations for performing defect inspection using a neural network model, and the operations may include: an operation of obtaining multiple input data having different domains; preprocessing first input data associated with a non-visual domain among the multiple input data; an operation of obtaining first training data based on second input data associated with a visual domain among the multiple input data, and the preprocessed first input data; and an operation of training a neural network model for performing defect inspection based on the first training data.

Alternatively, the operation of preprocessing the first input data associated with the non-visual domain among the multiple input data may include: an operation of setting a time-series interval for the first input data; and an operation of preprocessing the first input data based on the set time-series interval.

Alternatively, the operation of preprocessing the first input data based on the set time-series interval may include an operation of transforming an interval included in the set time-series interval in the first input data into spectrogram data.

Alternatively, the operation of preprocessing the first input data based on the set time-series interval may further include an operation of preprocessing second input data associated with a visual domain among the multiple input data.

Alternatively, the operation of preprocessing the second input data associated with the visual domain among the multiple input data may include at least one of an operation of adjusting a size of the second input data associated with the visual domain; an operation of performing normalization for the second input data; or an operation of performing image augmentation for the second input data.

Alternatively, the operation of obtaining the first training data based on the second input data associated with the visual domain among the multiple input data, and the preprocessed first input data may include: an operation of obtaining a correct answer label corresponding to the preprocessed first input data and the second input data; and an operation of obtaining first training data based on the preprocessed first input data, the second input data, and the correct answer label.

Alternatively, the operation of training the neural network model for performing the defect inspection based on the first training data may include: an operation of obtaining a first feature by inputting first input data included in the first training data into the neural network model, and obtaining a second feature by inputting second input data included in the first training data into the neural network model; an operation of performing, by utilizing the neural network model, the defect prediction based on the first feature and the second feature; and an operation of comparing the defect prediction result with the first training data to train the neural network model.

Alternatively, the operation of obtaining the first feature by inputting the first input data included in the first training data into the neural network model may include: an operation of obtaining first concatenated data based on first-first input data and first-second input data included in the first training data; and an operation of obtaining a first feature by inputting the first concatenated data into the neural network model.

Yet another exemplary embodiment of the present disclosure provides a computing device. The device may include: at least one processor; and a memory, and the processor may be configured to obtain multiple input data having different domains; preprocess first input data associated with a non-visual domain among the multiple input data; obtain first training data based on second input data associated with a visual domain among the multiple input data, and the preprocessed first input data; and train a neural network model for performing defect inspection based on the first training data.

Still yet another exemplary embodiment of the present disclosure provides a data structure included in a computer-readable storage medium. The data structure may correspond to a parameter of a neural network, and the neural network may perform the following steps at least partially based on the parameter, and the steps may include: obtaining multiple input data having different domains; preprocessing first input data associated with a non-visual domain among the multiple input data; obtaining first training data based on second input data associated with a visual domain among the multiple input data, and the preprocessed first input data; and training a neural network model for performing defect inspection based on the first training data.

The present disclosure relates to a method for performing defect inspection using multiple domain data, and more particularly, can improve accuracy of defect inspection by performing preprocessing for multiple input data having different domains such as a non-visual domain and a visual domain, obtaining training data based on the input data for which the preprocessing is performed, and training a neural network model for performing defect inspection using the training data.

Meanwhile, the effects of the present disclosure are not limited to the above-mentioned effects, and various effects can be included within the scope which is apparent to those skilled in the art from contents to be described below.

### BRIEF DESCRIPTION OF THE DRAWINGS

FIG. 1 is a block diagram of a computing device for performing defect inspection using multiple domain data according to an exemplary embodiment of the present disclosure.

FIG. 2 is a schematic diagram illustrating a network function according to an exemplary embodiment of the present disclosure.

FIG. 3 is a flowchart illustrating a method for performing defect inspection using multiple domain data according to an exemplary embodiment of the present disclosure.

FIGS. 4A and 4B are schematic diagrams for describing a process of obtaining multiple input data having different domains and preprocessing the multiple input data according to an exemplary embodiment of the present disclosure.

FIG. 5 is a schematic diagram for describing a process of obtaining first training data based on multiple input data according to an exemplary embodiment of the present disclosure.

FIG. 6 is a schematic diagram for describing a process of training a neural network model for performing defect inspection based on the first training data according to an exemplary embodiment of the present disclosure.

FIGS. 7A to 7C are schematic diagrams for describing a structure of a neural network model for performing defect inspection according to an exemplary embodiment of the present disclosure.

FIG. 8 is a simple and normal schematic diagram of an exemplary computing environment in which the exemplary embodiments of the present disclosure may be implemented.

### DETAILED DESCRIPTION

Various exemplary embodiments will now be described with reference to drawings. In the present specification, various descriptions are presented to provide appreciation of the present disclosure. However, it is apparent that the exemplary embodiments can be executed without the specific description.

“Component”, “module”, “system”, and the like which are terms used in the specification refer to a computer-related entity, hardware, firmware, software, and a combination of the software and the hardware, or execution of the software. For example, the component may be a processing procedure executed on a processor, the processor, an object, an execution thread, a program, and/or a computer, but is not limited thereto. For example, both an application executed in a computing device and the computing device may be the components. One or more components may reside within the processor and/or a thread of execution. One component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

It should be appreciated that the term “comprise” and/or “comprising” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

The term “at least one of A or B” should be interpreted to mean “a case including only A”, “a case including only B”, and “a case in which A and B are combined”.

Those skilled in the art need to recognize that various illustrative logical blocks, configurations, modules, circuits, means, logic, and algorithm steps described in connection with the exemplary embodiments disclosed herein may be additionally implemented as electronic hardware, computer software, or combinations of both sides. To clearly illustrate the interchangeability of hardware and software, various illustrative components, blocks, configurations, means, logic, modules, circuits, and steps have been described above generally in terms of their functionalities. Whether the functionalities are implemented as the hardware or software depends on a specific application and design restrictions given to an entire system. Skilled artisans may implement the described functionalities in various ways for each particular application. However, such implementation decisions should not be interpreted as causing a departure from the scope of the present disclosure.

The description of the presented exemplary embodiments is provided so that those skilled in the art of the present disclosure use or implement the present disclosure. Various modifications to the exemplary embodiments will be apparent to those skilled in the art. Generic principles defined herein may be applied to other embodiments without departing from the scope of the present disclosure. Therefore, the present disclosure is not limited to the exemplary embodiments presented herein. The present disclosure should be analyzed within the widest range which is coherent with the principles and new features presented herein.

In the present disclosure, a network function and an artificial neural network and a neural network may be interchangeably used.

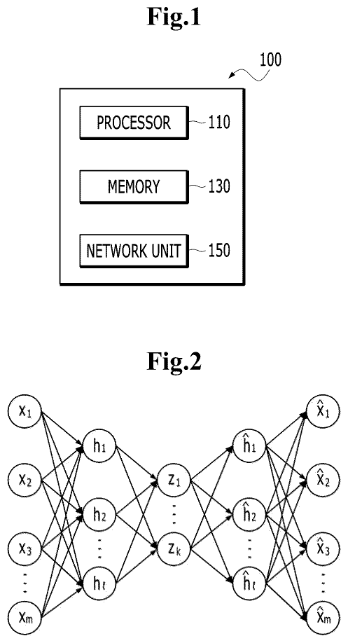

FIG. 1 is a block diagram of a computing device for performing defect inspection using multiple domain data according to an exemplary embodiment of the present disclosure.

A configuration of the computing device 100 illustrated in FIG. 1 is only an example shown through simplification. In an exemplary embodiment of the present disclosure, the computing device 100 may include other components for performing a computing environment of the computing device 100 and only some of the disclosed components may constitute the computing device 100.

The computing device 100 may include a processor 110, a memory 130, and a network unit 150.

The processor 110 may be constituted by one or more cores and may include processors for data analysis and deep learning, which include a central processing unit (CPU), a general purpose graphics processing unit (GPGPU), a tensor processing unit (TPU), and the like of the computing device. The processor 110 may read a computer program stored in the memory 130 to perform data processing for machine learning according to an exemplary embodiment of the present disclosure. According to an exemplary embodiment of the present disclosure, the processor 110 may perform a calculation for training the neural network. The processor 110 may perform calculations for training the neural network, which include processing of input data for training in deep learning (DL), extracting a feature in the input data, calculating an error, updating a weight of the neural network using backpropagation, and the like. At least one of the CPU, GPGPU, and TPU of the processor 110 may process training of a network function. For example, both the CPU and the GPGPU may process the training of the network function and data classification using the network function. Further, in an exemplary embodiment of the present disclosure, processors of a plurality of computing devices may be used together to process the training of the network function and the data classification using the network function. Further, the computer program executed in the computing device according to an exemplary embodiment of the present disclosure may be a CPU, GPGPU, or TPU executable program.

According to an exemplary embodiment of the present disclosure, the memory 130 may store any type of information generated or determined by the processor 110 and any type of information received by the network unit 150.

According to an exemplary embodiment of the present disclosure, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The description of the memory is just an example and the present disclosure is not limited thereto.

The network unit 150 according to an exemplary embodiment of the present disclosure may use various wired communication systems such as public switched telephone network (PSTN), x digital subscriber line (xDSL), rate adaptive DSL (RADSL), multi rate DSL (MDSL), very high speed DSL (VDSL), universal asymmetric DSL (UADSL), high bit rate DSL (HDSL), and local area network (LAN).

The network unit 150 presented in the present disclosure may use various wireless communication systems such as code division multi access (CDMA), time division multi access (TDMA), frequency division multi access (FDMA), orthogonal frequency division multi access (OFDMA), single carrier-FDMA (SC-FDMA), and other systems.

In the present disclosure, the network unit 110 may be configured regardless of a communication aspect, such as wired communication and wireless communication, and may be configured by various communication networks, such as a Personal Area Network (PAN) and a Wide Area Network (WAN). Further, the network may be a publicly known World Wide Web (WWW), and may also use a wireless transmission technology used in short range communication, such as Infrared Data Association (IrDA) or Bluetooth.

FIG. 2 is a conceptual view illustrating a neural network according to an exemplary embodiment of the present disclosure.

Throughout the present specification, a computation model, the neural network, a network function, and the neural network may be used as the same meaning. The neural network may be generally constituted by an aggregate of calculation units which are mutually connected to each other, which may be called nodes. The nodes may also be called neurons. The neural network is configured to include one or more nodes. The nodes (alternatively, neurons) constituting the neural networks may be connected to each other by one or more links.

In the neural network, one or more nodes connected through the link may relatively form the relationship between an input node and an output node. Concepts of the input node and the output node are relative and a predetermined node which has the output node relationship with respect to one node may have the input node relationship in the relationship with another node and vice versa. As described above, the relationship of the input node to the output node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable and the weight is variable by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form a relationship of the input node and output node in the neural network. A characteristic of the neural network may be determined according to the number of nodes, the number of links, correlations between the nodes and the links, and values of the weights granted to the respective links in the neural network. For example, when the same number of nodes and links exist and there are two neural networks in which the weight values of the links are different from each other, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links which should be passed through for reaching the corresponding node from the initial input node. However, a definition of the layer is predetermined for description and the order of the layer in the neural network may be defined by a method different from the aforementioned method. For example, the layers of the nodes may be defined by the distance from a final output node.

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean nodes constituting the neural network other than the initial input node and the final output node.

In the neural network according to an exemplary embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another exemplary embodiment of the present disclosure, the number of nodes of the input layer may be smaller than the number of nodes of the output layer, and the neural network may be a neural network of a type in which the number of nodes decreases from the input layer to the hidden layer. Further, in the neural network according to yet another exemplary embodiment of the present disclosure, the number of nodes of the input layer may be larger than the number of nodes of the output layer, and the neural network may be a neural network of a type in which the number of nodes increases from the input layer to the hidden layer. The neural network according to still yet another exemplary embodiment of the present disclosure may be a neural network of a type in which the neural networks are combined.

A deep neural network (DNN) may refer to a neural network that includes a plurality of hidden layers in addition to the input and output layers. When the deep neural network is used, the latent structures of data may be determined. That is, latent structures of photos, text, video, voice, and music (e.g., what objects are in the photo, what the content and feelings of the text are, what the content and feelings of the voice are) may be determined. The deep neural network may include a convolutional neural network (CNN), a recurrent neural network (RNN), an auto encoder, generative adversarial networks (GAN), a restricted Boltzmann machine (RBM), a deep belief network (DBN), a Q network, a U network, a Siam network, a Generative Adversarial Network (GAN), and the like. The description of the deep neural network described above is just an example and the present disclosure is not limited thereto.

In an exemplary embodiment of the present disclosure, the network function may include the auto encoder. The auto encoder may be a kind of artificial neural network for outputting output data similar to input data. The auto encoder may include at least one hidden layer and odd hidden layers may be disposed between the input and output layers. The number of nodes in each layer may be reduced from the number of nodes in the input layer to an intermediate layer called a bottleneck layer (encoding), and then expanded symmetrical to reduction to the output layer (symmetrical to the input layer) in the bottleneck layer. The auto encoder may perform non-linear dimensional reduction. The number of input and output layers may correspond to a dimension after preprocessing the input data. The auto encoder structure may have a structure in which the number of nodes in the hidden layer included in the encoder decreases as a distance from the input layer increases. When the number of nodes in the bottleneck layer (a layer having a smallest number of nodes positioned between an encoder and a decoder) is too small, a sufficient amount of information may not be delivered, and as a result, the number of nodes in the bottleneck layer may be maintained to be a specific number or more (e.g., half of the input layers or more).

The neural network may be trained in at least one scheme of supervised learning, unsupervised learning, semi supervised learning, or reinforcement learning. The learning of the neural network may be a process in which the neural network applies knowledge for performing a specific operation to the neural network.

The neural network may be trained in a direction to minimize errors of an output. The training of the neural network is a process of repeatedly inputting training data into the neural network and calculating the output of the neural network for the training data and the error of a target and back-propagating the errors of the neural network from the output layer of the neural network toward the input layer in a direction to reduce the errors to update the weight of each node of the neural network. In the case of the supervised learning, the training data labeled with a correct answer (e.g., a ground-truth label) is used for each training data (i.e., the labeled training data) and in the case of the unsupervised learning, the correct answer may not be labeled in each training data. That is, for example, the training data in the case of the supervised learning related to the data classification may be data in which category is labeled in each training data. The labeled training data is input to the neural network, and the error may be calculated by comparing the output (category) of the neural network with the label of the training data. As another example, in the case of the unsupervised learning related to the data classification, the training data as the input is compared with the output of the neural network to calculate the error. The calculated error is back-propagated in a reverse direction (i.e., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the back-propagation of the error may constitute a training cycle (epoch). The learning rate may be applied differently according to the number of repetition times of the training cycle of the neural network. For example, in an initial stage of the training of the neural network, the neural network ensures a certain level of performance quickly by using a high learning rate, thereby increasing efficiency and uses a low learning rate in a latter stage of the training, thereby increasing accuracy.

In training of the neural network, the training data may be generally a subset of actual data (i.e., data to be processed using the trained neural network), and as a result, there may be a training cycle in which errors for the training data decrease, but the errors for the actual data increase. Overfitting is a phenomenon in which the errors for the actual data increase due to excessive training of the training data. For example, a phenomenon in which the neural network that trains a cat by showing a yellow cat sees a cat other than the yellow cat and does not recognize the corresponding cat as the cat may be a kind of overfitting. The overfitting may act as a cause which increases the error of the machine learning algorithm. Various optimization methods may be used in order to prevent the overfitting. In order to prevent the overfitting, a method such as increasing the training data, regularization, dropout of omitting a part of the node of the network in the process of training, utilization of a batch normalization layer, etc., may be applied.

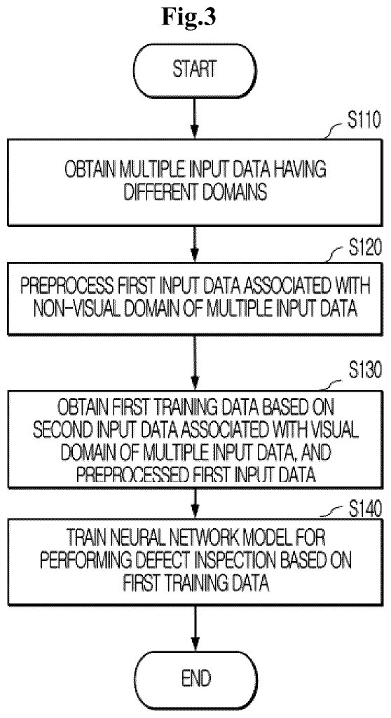

FIG. 3 is a flowchart illustrating a method for performing defect inspection using multiple domain data according to an exemplary embodiment of the present disclosure.

A computing device 100 according to an exemplary embodiment of the present disclosure may directly obtain or receive, from an external system, “information for performing defect inspection using multiple domain data”. The external system may be a server, database, or the like that stores and manages the information for performing defect inspection using multiple domain data. The computing device 100 may use the information obtained directly or received from the external system as “input data for performing defect inspection using multiple domain data”.

According to an exemplary embodiment of the present disclosure, the computing device 100 may obtain multiple input data having different domains (S110). In this case, the multiple input data having different domains may include first input data associated with a non-visual domain and second input data associated with a visual domain. In addition, the first input data may include time-series data, and may include, for example, sensor data of a process such as current sensor data, voltage sensor data, gas flow sensor data, or the like, but is not limited to the example. Meanwhile, the second input data may include image data of an article, but data associated with various visual domains such as a moving image may be utilized in addition to the example of the image. Meanwhile, the obtained multiple input data may be utilized in a process of obtaining training data for training a neural network model for performing defect inspection, which will be described below.

According to an exemplary embodiment of the present disclosure, the computing device 100 may preprocess the first input data associated with the non-visual domain among the multiple input data obtained through step S110 (S120). Specifically, the computing device 100 may set a time-series interval for the first input data, and preprocess the first input data based on the set time-series interval. In this case, the set time-series interval may mean a preset time interval such as 0.2 seconds, but various examples may be applied in addition to the 0.2 seconds. For example, the computing device 100 may transform an interval included in the set time-series interval in the first input data into spectrogram data. In this regard, the computing device 100 may efficiently extract features from data composed of multiple domains in a process of inspecting a defect of an article through a neural network model for performing defect inspection by transforming the interval included in the set time-series interval in the first input data into the spectrogram data, and may utilize the features together.

Additionally, the computing device 100 may preprocess second input data associated with a visual domain among the multiple input data. For example, the computing device 100 may preprocess the second input data based on at least one of a process of adjusting a size of the second input data associated with the visual domain, a process of performing normalization for the second input data, or a process of performing image augmentation for the second input data. In this case, the image augmentation may include, but is not limited to, image augmenting methods such as vertical/horizontal inversion, brightness/contrast adjustment, and the like. Meanwhile, the preprocessed first or second input data may be utilized in a process of obtaining training data for training a neural network model for performing defect inspection, which will be described below in detail with reference to FIG. 5 below.

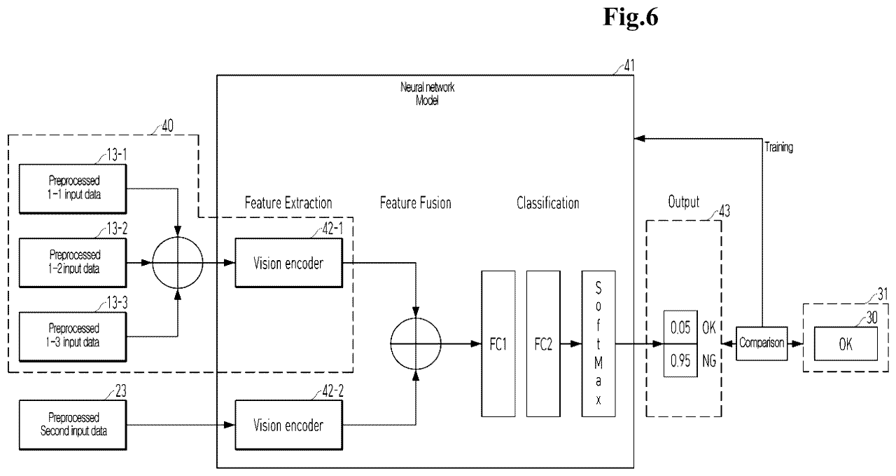

According to an exemplary embodiment of the present disclosure, the computing device 100 may obtain first training data based on the first input data preprocessed through step S120 and second input data associated with a visual domain among the multiple input data (S130). Specifically, the computing device 100 may obtain a correct answer label corresponding to the preprocessed first input data and the second input data, and obtain first training data based on the preprocessed first input data, the second input data, and the correct answer label. For example, the computing device 100 may obtain a correct answer label such as normal (OK)/abnormal (NG) for the “states of preprocessed first-first and first-second input data and second input data” corresponding to a preset first time-series interval, and may obtain first training data by configuring the “the preprocessed first-first and first-second input data, and the second input data” and the correct answer label as a pair. Meanwhile, the obtained first training data may be utilized in a process of training a neural network model for performing defect inspection, which will be described below in detail with reference to FIG. 6 below.

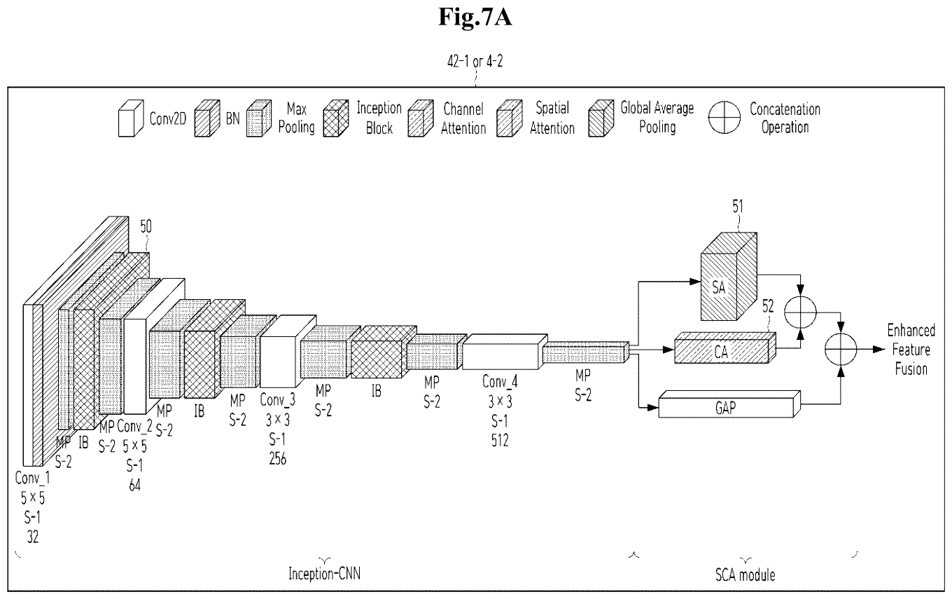

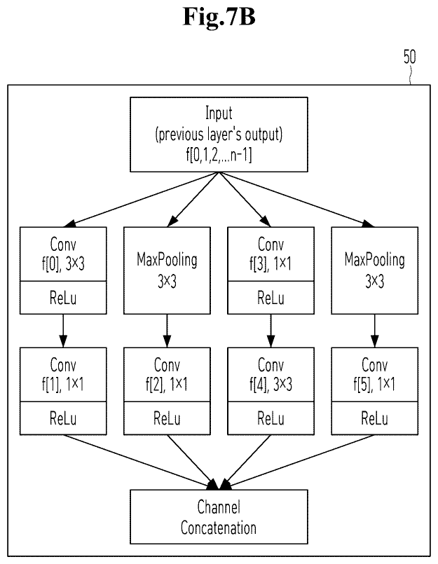

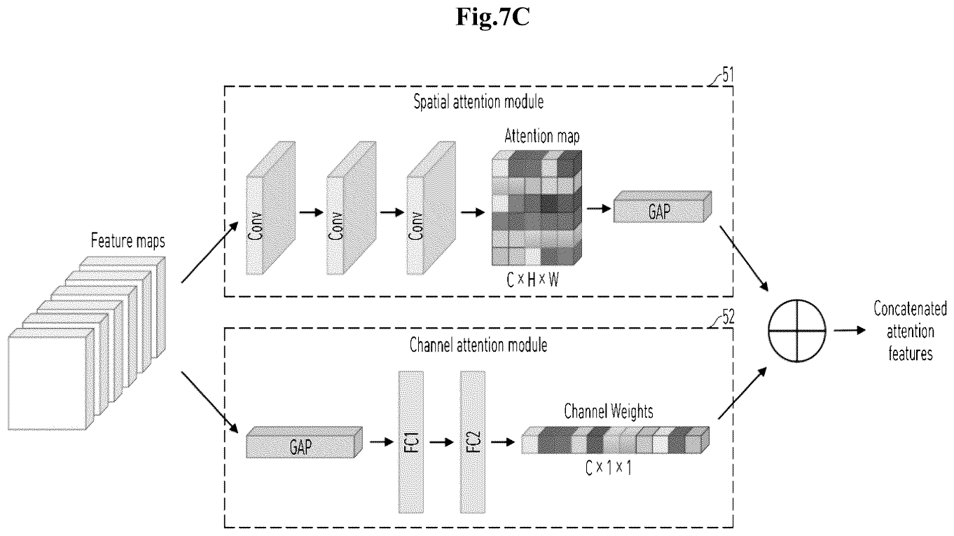

According to an exemplary embodiment of the present disclosure, the computing device 100 may train a neural network model for performing defect inspection based on the first training data obtained through step S130 (S140). In this case, the neural network model may include an encoder for extracting a visual feature from input data. In addition, the encoder for extracting the visual feature may include at least one of an extraction block for extracting features of different sizes from input data, a first module for identifying a feature region related to whether there is a defect based on multiple features extracted from the input data, or a second module for identifying a feature related to whether there is a defect among the multiple features extracted from the input data, and a structure of the neural network model will be described below in detail with reference to FIG. 6 and FIG. 7A to 7C below. Specifically, the computing device 100 may obtain a first feature by inputting first input data included in the first training data into the neural network model, and obtain a second feature by inputting second input data included in the first training data into the neural network model. In this case, the computing device 100 may obtain first concatenated data based on the first-first input data and the first-second input data included in the first training data, and obtain a first feature by inputting the first concatenated data into the neural network model. In this regard, in order to increase the accuracy of defect inspection through the neural network model, a process of extracting a feature separately for each of the multiple input data is required. However, in a process in which the computing device 100 extracts a feature for each of the multiple input data composed of the different domains, an individual encoder is required for each of the multiple input data, so that parameters of the neural network model may be excessively increased, which may reduce a learning speed and a defect inspection speed of the neural network model. Therefore, the computing device 100 may obtain first concatenated data based on the first-first input data and the first-second input data included in the first training data, and input the first concatenated data into the neural network model to obtain the first feature, thereby adjusting parameters of the neural network model at an appropriate level even when sensor input data of different domains is added, increasing the defect inspection speed, and enabling real-time defect detection during a process to obtain a technical effect of improving process control and overall product quality. Then, the computing device 100 may utilize the neural network model to perform the defect inspection based on the first feature and the second feature, and compare the combined inspection result with the first training data to train the neural network model. Meanwhile, the process of training, by the computing device 100, the neural network model for performing the defect inspection based on the first training data will be described below in detail with reference to FIG. 6 below.

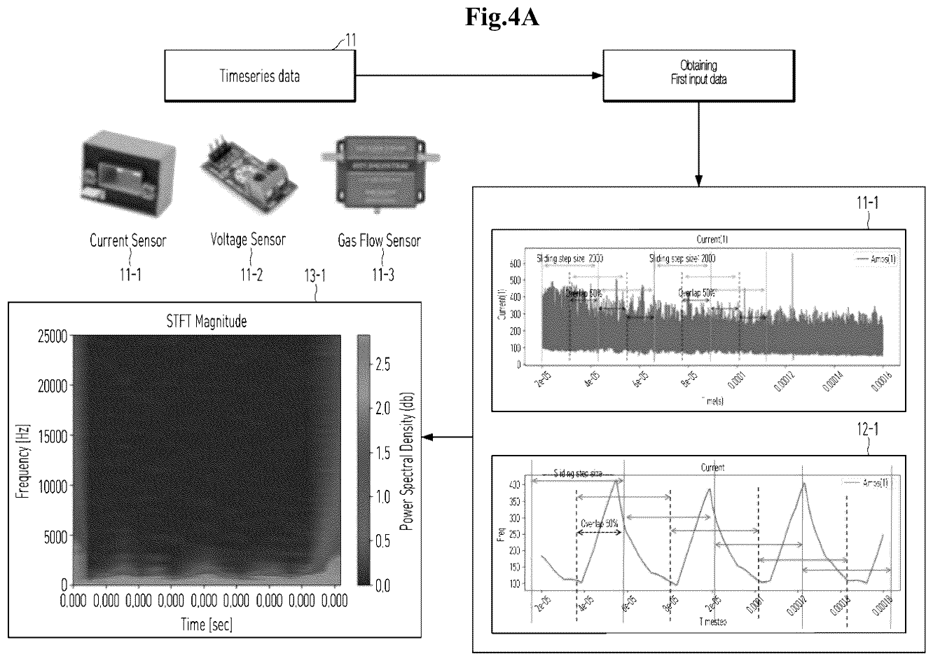

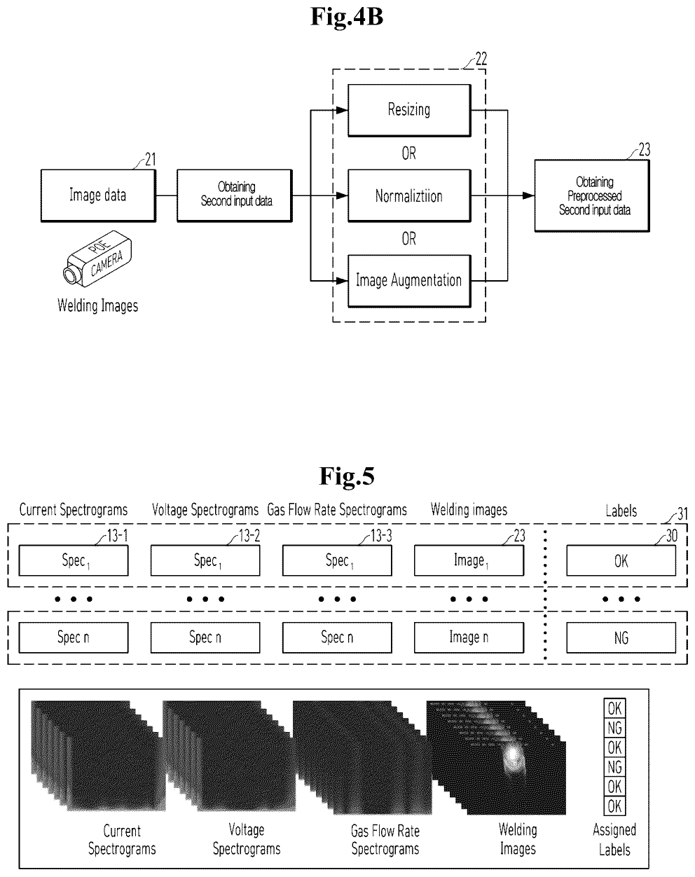

FIGS. 4A and 4B are schematic diagrams for describing a process of obtaining multiple input data having different domains and preprocessing the multiple input data according to an exemplary embodiment of the present disclosure.

Referring first to FIG. 4A, the computing device 100 may obtain first input data 11 associated with at least one non-visual domain of multiple input data having different domains. In this case, the first input data 11 may include time-series data, and may include, for example, sensor data of a process such as first-first input data 11-1 obtained by a current sensor, first-second input data 11-2 obtained by a voltage sensor, or first-third input data 11-3 obtained by a gas flow sensor, but is not limited to the example.

In addition, the computing device 100 may preprocess the first input data 11 associated with the non-visual domain. Specifically, the computing device 100 may set a time-series interval for the first input data, and preprocess the first input data 11 based on the set time-series interval. In this case, the set time series interval may mean a preset time interval such as 0.2 seconds, but various examples may be applied in addition to the 0.2 seconds. In the example of FIG. 4A, the computing device 100 may transform a first time-series interval 12-1 of the intervals included in the time-series interval set for the first-first input data 11-1 into first-first spectrogram data (i.e., preprocessed first-first input data 13-1). Through this, the computing device 100 may efficiently extract features from data composed of multiple domains in a process of inspecting a defect of an article through a neural network model for performing defect inspection by transforming the interval included in the set time-series interval in the first input data into the spectrogram data, and may utilize the features together. In addition, the computing device 100 may set a starting point of the second time-series interval so as to have a preset degree of overlapping region with respect to the first time-series interval 12-1 and the second time-series interval, and exemplarily, the computing device 100 may set a starting point of the second time-series interval so as to have 50% of overlapping region with respect to the first time-series interval 12-1 and the second time-series interval. In this regard, the computing device 100 may set the starting point of the second time-series interval so that the first time-series interval 12-1 and the second time-series interval have the 50% of overlapping region, and obtain the first-first spectrogram data and the first-second spectrogram data based thereon, thereby enabling real-time defect inspection in the process of inspecting a defect of an article through the neural network model for performing defect inspection to be described later, thereby improving process control and overall product quality.

Referring now to FIG. 4B, the computing device 100 may obtain second input data 21 associated with the visual domain of multiple input data having different domains, and preprocess the second input data (22). In this case, the second input data 21 may include image data of the article, but data associated with various visual domains such as a moving image may be utilized in addition to the example of the image. For example, the computing device 100 may preprocess the second input data 21 (22) based on at least one of a process of adjusting a size of the second input data 21 associated with the visual domain, a process of performing normalization for the second input data 21, or a process of performing image augmentation for the second input data 21. In this case, the image augmentation may include, but is not limited to, image augmenting methods such as vertical/horizontal inversion, brightness/contrast adjustment, and the like. Meanwhile, the preprocessed first input data 13-1 or the preprocessed second input data 23 may be utilized in a process of obtaining training data for training the neural network model for performing the defect inspection, which will be described below in detail with reference to FIG. 5 below.

FIG. 5 is a schematic diagram for describing a process of obtaining first training data based on multiple input data according to an exemplary embodiment of the present disclosure.

Referring to FIG. 5, the computing device 100 may obtain the first training data 31 based on the preprocessed first input data 13-1 to 13-3 and the preprocessed second input data 23. Specifically, the computing device 100 may obtain a first correct answer label 30 corresponding to the preprocessed first input data 13-1 to 13-3 and the preprocessed second input data 23, and obtain first training data 31 based on the preprocessed the first input data 13-1 to 13-3, the second input data 23 and OK 30 that is the first correct answer label. For example, the computing device 100 may obtain a correct answer label such as normal (OK)/abnormal (NG) for the “states of preprocessed first input data 13-1 to 13-3 and the preprocessed second input data 23” corresponding to the preset first time-series interval, and may obtain the first training data 31 by configuring the “the preprocessed first input data 13-1 to 13-3, and the preprocessed second input data 23” and the first correct answer label 30 as a pair. In addition, the computing device 100 may repeat the process as in the exemplary embodiment to obtain second training data, third training data, or n-th training data, and the obtained first, second, . . . , or n-th training data may be utilized in the process of training the neural network model for performing the defect inspection, which will be described below in detail with reference to FIG. 6 below.

FIG. 6 is a schematic diagram for describing a process of training a neural network model for performing defect inspection based on the first training data according to an exemplary embodiment of the present disclosure.

Referring to FIG. 6, the computing device 100 may train a neural network model 41 for performing the defect inspection based on the obtained first training data 31. In this case, the neural network model 41 may include an encoder 42-1 or 42-2 for extracting a visual feature from input data. In addition, the encoder 42-1 or 42-2 for extracting the visual feature may include at least one of an extraction block for extracting features of different sizes from input data, a first module for identifying a feature region related to whether there is a defect based on multiple features extracted from the input data, or a second module for identifying a feature related to whether there is a defect among the multiple features extracted from the input data, and a structure of the encoder 42-1 or 42-2 for extracting the visual feature will be described below in detail with reference to FIGS. 7A to 7C below.

Specifically, the computing device 100 may obtain a first feature by inputting first input data included in the first training data 31 into the first encoder 42-1 of the neural network model, and obtain a second feature by inputting second input data included in the first training data to the second encoder 42-2 . . . . In this case, the computing device 100 may obtain first concatenated data based on preprocessed first-first input data 13-1, preprocessed first-second input data 13-2, and preprocessed first-third input data 13-3 included in the first training data 31, and obtain the first feature by inputting the first concatenated data into the first encoder 42-1 of the neural network model. In this regard, in order to increase the accuracy of the defect inspection through the neural network model 41, a process of extracting the feature separately for each of the multiple preprocessed input data 13-1 to 13-3, and 23 is required. However, in a process in which the computing device 100 extracts the feature for each of the multiple preprocessed input data 13-1 to 13-3, and 23 composed of the different domains, an individual encoder is required for each of the multiple preprocessed input data 13-1 to 13-3, and 23, so that parameters of the neural network model may be excessively increased, which may reduce a learning speed and a defect inspection speed of the neural network model 41. Therefore, the computing device 100 may obtain the first concatenated data based on the preprocessed first-first input data 13-1, the preprocessed first-second input data 13-2, and the preprocessed first-third input data 13-3 included in the first training data 31, and obtain the first feature by inputting the first concatenated data into the first encoder 42-1 of the neural network model, thereby adjusting parameters of the neural network model at an appropriate level even when sensor input data of different domains is added, increasing the defect inspection speed, and enabling real-time defect detection during a process to obtain a technical effect of improving process control and overall product quality. As a specific example, when the preprocessed first-first input data 13-1, the preprocessed first-second input data 13-2, the preprocessed first-third input data 13-3, and the preprocessed second input data 23 each having a size of 360×640×3 (H×W×CH) are input to encoders of the neural network model 41 having the number of parameters of 5 million, respectively without obtaining the first concatenated data, four encoders are required, and thus the number of parameters may be 20 million. On the other hand, when the first-first input data 13-1, the first-second input data 13-2, and the first-third input data 13-3 each having a size of 360×640×3 (H×W×CH) are concatenated to obtain first concatenated data having a size of 360×640×3 (H×W×CH), and the first concatenated data and the second input data 23 are input into encoders of the neural network model 41 having the number of parameters of 5 million, respectively, only two encoders are required, and thus the number of parameters may be 10 million. As described above, the computing device 100 may obtain the first concatenated data based on the preprocessed first-first input data 13-1, the preprocessed first-second input data 13-2, and the preprocessed first-third input data 13-3, and input the obtained first concatenated data into the neural network model 41, so that even if sensor input data of different domains is added, it is possible to adjust the parameters of the neural network model 41 at an appropriate level, increase a defect inspection speed, and obtain a technical effect of enabling real-time defect detection during a process to improve process control and overall product quality.

Then, the computing device 100 may utilize the neural network model 41 to perform defect inspection based on the first feature and the second feature extracted through the first and second encoders 42-1 and 42-2, and compare a defect inspection result 43 with the first correct answer label 30 included in the first training data to train the neural network model 41. Specifically, the computing device 100 may combine the first feature and the second feature, and make a classification network composed of two fully connected layers FC1 and FC2 of the neural network model 41, and a RecFied Linear Unit (ReLu) activation unit, and then predict whether there is a defect through a SoftMax activation unit for predicting a class probability indicating a possibility that the defect will exist. In addition, the computing device 100 may compare whether the defect exists, which is predicted with the first correct answer label 30, and train the neural network model 41 so that whether the defect exists predicted defect approaches the first correct answer label 30, thereby learning a decision boundary between a defect-existence (NG) class and a defect-non-existence (OK) class. Then, the computing device 100 may perform an evaluation for the trained neural network model based on at least one of the obtained first to n-th training data that is not used for training, and may end training when the accuracy of an evaluation result is greater than or equal to a preset threshold, and may perform additional training when the accuracy is less than the preset threshold. In this case, the preset threshold may be exemplarily 0.995 or the like, but various other embodiments may be utilized.

FIGS. 7A to 7C are schematic diagrams for describing a structure of a neural network model for performing defect inspection according to an exemplary embodiment of the present disclosure.

Referring first back to FIG. 7A, the encoder 42-1 or 42-2 for extracting the visual feature, which are included in the neural network model 41, may include at least one of an extraction block 50 for extracting features of different sizes from input data, a first module 51 for identifying a feature region related to whether there is a defect based on multiple features extracted from the input data, or a second module 52 for identifying a feature related to whether there is a defect among the multiple features extracted from the input data. Specifically, when the preprocessed first or second input data 13 or 23 in the range of 256×256 to 380×380 is input to the encoder 42-1 or 42-2 for extracting the visual feature, the computing device 100 may scan the preprocessed first or second input data 13 or 23 through a convolutional layer having 32 filters and a 5×5 kernel included in the encoder 42-1 or 42-2. In addition, a batch normalization layer is applied to the encoder 42-1 or 42-2 for stable training, and nonlinearity may be introduced into an ReLU activation function. Additionally, in the encoder 42-1 or 42-2, a MaxPooling layer may be used to reduce the feature map extracted through the convolutional layer. Then, the feature map extracted through the convolutional layer may pass through the first extraction block 50, and the first extraction block 50 includes convolutional layers having different filter sizes in parallel, so that the neural network model 41 may recognize features of various sizes of input data. In addition, the feature map that passes through the first extraction block may be input to an intermediate convolution layer having 64 filters and the 5×5 kernel, and the intermediate convolutional layer may subdivide the features learned in the previous step and further reduce a spatial size of the feature map, so as to concatenate and abstract the features for high-dimensional recognition.

In this regard, with reference to FIG. 7B for the structure of the first extraction block 50, the first extraction block 50 according to an exemplary embodiment of the present disclosure may include multiple detail layers, a first-first detail layer in a first row of a first column and a second detail layer in a second row of a second column included in the first block may have different numbers of filters, and the first-first detail layer and the second detail layer may be configured in parallel. For example, multiple detail layers included in the first extraction block 50 may mean convolutional layers or pooling layers (in the example of FIG. 7B, a maximum pooling layer in which a kernel size is 3×3, a stride is 1, and padding is the same). In this case, since the maximum pooling layer divides the input feature map into non-overlapping rectangular regions and selects a maximum value in each region, the size of the resultant output feature map is reduced, so that the calculation complexity of the model may be reduced and overfitting may be prevented. Meanwhile, f[0, 1, 2, . . . 5] may mean the number of filters included in each detailed layer. However, f[0-5] is merely an example and is not limited thereto, and various examples may be utilized. Specifically, the number of filters included in the first-first detail layer may mean f[0], the number of filters included in each of the first-second detail layers may mean f[1], and the number of filters included in the second detail layer may mean f[2]. For example, in the case of the first extraction block 50 configured with detail layers of which the numbers of filters are 32, 16, 16, 32, 16, and 16, respectively, the size of the kernel of the first-first detail layer may be configured as 3×3, the number of filters may be configured as 32, the size of the kernel of the first-second detail layer may be configured as 1×1, the number of filters may be configured as 16, the size of kernels of the second detail layer may be configured as 1×1, and the number of filters may be configured as 16, the size of the kernel of the third-1 detail layer may be configured as 1×1, the number of filters may be configured as 32, and the size of the kernel of the third-2 detail layer may be configured as 3×3, and the number of filtrates may be configured as 16. Meanwhile, the computing device 100 may input a first feature map input into the first extraction block 50 into the first-first detail layer and the first-second detail layer to extract a first detail feature map, input the first feature map into the second detail layer to extract the second detail feature map, and input the first feature map into the third-1 detail layer and the third-2 detail layer to extract a third detail feature map. First, the computing device 100 may grasp a local feature of the first feature map by inputting the first feature map into the first-first detail layer having the kernel size of 3×3, and may extract the local feature and a feature between channels in the first feature map by inputting an output of the first-first detail layer to the first-second detail layer having the kernel size of 1×1 to obtain the first detail feature map. In addition, the computing device 100 may input a first feature map to a maximum pooling layer to reduce a spatial size of the first feature map and emphasize a main characteristic, and may input an output of the maximum pooling layer into the second detail layer having the kernel size of 1×1 to obtain a second detail feature map, thereby extracting the feature between the channels in the first feature map, and may reduce an amount of computation because the number of channels is the same as a previous input. Additionally, the computing device 100 may reduce the amount of computation required by reducing the channel of the first feature map and then re-expanding through the third-2 detail layer by using the third-1 detail layer in which the size of the kernel is 1×1. For example, when the computing device 100 uses only the third to second detail layers in which the size of the kernel is 3×3, the kernel of the size of 3×3 may be represented by one value by considering information between channels as well as local information, so that one kernel should perform both roles. Unlike this, if the third-1 detail layer having the kernel size of 1×1 is first used, the kernel having the size of 1×1, which serves to adjust a channel, may extract the features between the channel, and then the third-2 detail layer, which has the kernel size of 3×3, may extract features by focusing only on local information of the data to be determined. Accordingly, the computing device 100 may first use the third-1 detail layer, and then extract a third detail feature map using the third-2 detail layer 23-5, thereby segmenting the roles of the two detail layers having different kernel sizes. In other words, with respect to channel-to-channel relationship information, parameters used in the third-1 detail layer whose kernel size is 1×1 may be may be connected to each other, and with respect to local information of the data to be determined, parameters used in the third-2 detail layer whose kernel size is 3×3 may be connected to each other. Additionally, the computing device 100 may obtain a second feature map by channel-wise concatenating the obtained first, second, and third detail feature maps. In this case, the computing device 100 may obtain a feature map (for example, a second feature map or the like) having a visual feature of the preprocessed input data 13 or 23 at various sizes and resolutions by using multiple detail layers having different sizes of kernels and different numbers of filters included in the one or more blocks in parallel, and the neural network model 41 may obtain a defect pattern and detailed information of the preprocessed input data 13 or 23 at various scales and resolutions through the feature map (for example, the second feature map or the like). In addition, in the process of predicting whether the preprocessed input data 13 or 23 is defective, the computing device 100 may use the feature map (for example, the second feature map or the like) having the visual feature of the preprocessed input data 13 or 23 to increase the accuracy of prediction. In summary, the computing device 100 predicts whether there is a defect in the preprocessed input data 13 or 23 by using the neural network model 41 including one or more layers and one or more extraction blocks 50, so that the defect pattern and detailed information of the data to be determined may be obtained at various scales and resolutions, and accuracy of a defect prediction result may be improved.

Then, the feature maps which pass through the Inception-CNN included in the encoder 42-1 or 42-2 may be input into an SCA module, and the SCA module may include at least one of a first module 51 for identifying a feature region related to whether there is a defect, or a second module 52 for identifying a feature related to whether there is a defect among multiple features extracted from the input data, based on the multiple features extracted from the input data.

In this regard, referring to FIG. 7C for the structure of the SCA module, the computing device 100 may input the feature maps passing through the Inception-CNN included in the encoder 42-1 or 42-2 into one or more convolutional layers included in the first module 51, and perform global average pooling for a spatial feature map obtained therethrough to extract a spatial feature vector for identifying a feature region related to whether there is a defect, based on multiple features extracted from the input data. For example, the computing device 100 may input the feature maps into three convolution layers included in the first module 51, delete information of a channel by applying a convolution operation, and obtain a spatial feature map having spatial importance, and perform the global average pooling for the obtained spatial feature map to extract the spatial feature vector for identifying the feature region related to whether there is a defect. Through this, the extracted spatial feature vector may include “information of a feature region that is important in defect inspection for feature maps with spatial importance”.

For example, the spatial feature vector may be computed and extracted based on the following equation.

$$Spatial feature vector = GAP ( {Z}_{3}^{1 \times 1} ( {Z}_{2}^{3 \times 3} ( {Z}_{1}^{1 \times 1} ( Feature map ) ) ) ) \qquad Equation 1$$

In Equation 1 above, Z1, Z2, and Z3 may mean first, second, and third layers of three convolutional layers, respectively, and GAP may mean the global average pooling 50-2. In addition, the Z1 layer and the Z3 layer may include 64 filters having a size of 1×1, and the Z2 layer may include 64 filters having a size of 3×3. The computing device 100 may input the feature maps to the three convolution layers of Z1, Z2, and Z3, delete information of a channel by applying a convolution operation, and generate a spatial feature map having spatial importance, and perform global average pooling on the generated spatial feature map, so that one feature map having the spatial importance whose size is 2×2 in height×width may be converged to one value, so that the spatial feature map may be extracted as one spatial feature vector. For example, when the spatial feature map corresponds to feature maps each having a size of 2×2 that exist for each of 64 channels, a 1D-shape spatial feature vector having 64 values may be extracted when performing the global average pooling for a tensor shape of 2×2×64 (Height×Width×Channel). In addition, the computing device 100 may extract, from the spatial feature vector extracted through the first module 51, “information about a feature region that is important in defect inspection with respect to feature maps having spatial importance”, and the output value of the first module 51 may be applied in the defect prediction process through a process of concatenating a spatial feature vector including information about a feature region related to whether a defect exists with another feature vector to be described below.

In addition, the computing device 100 may input the feature maps that pass through the Inception-CNN into the second module 52 to perform the global average pooling, thereby obtaining a temporary channel feature vector. In addition, the computing device 100 may input the temporary channel feature vector into one or more fully connected layers, and extract the channel feature vector for identifying the feature related to whether there is a defect among multiple features. For example, the global average pooling may be performed on the feature maps to remove spatial information, and the temporary feature vector remaining only information of a channel may be input into two fully-connected layers to learn an important degree for each channel, and the channel feature vector for identifying a feature map most related to whether there is a defect among the feature maps may be extracted. For example, the channel feature vector may be computed and extracted based on the following equation.

$$Channel feature vector = {FC}_{2} ( {FC}_{1} ( Temporary channel feature vector ) ) \qquad Equation 2$$

In Equation 2 above, FC1 may mean a first layer of the two fully-connected layers, FC2 may mean a second layer of the two fully-connected layers, and a hidden layer of the FC1 may be set to 128 and the hidden layer of the FC2 may be set to 64, and through this, a size of the channel feature vector may be extracted as 64. Meanwhile, the process of extracting the channel feature vector through the second module 52 may include a channel attention process of focusing on requirement input feature points by utilizing the interdependency between channels, compressing channel information using Global Average Pooling (GAP), restoring the input feature points through the convolution layer, and reinforcing and restoring the input feature points for the part to be focused within the network. In addition, the computing device 100 may extract a feature map most related to whether there is the defect among the feature maps through the channel attention process using the second module 52, and an output value of channel attention may be applied in a defect prediction process through a process of concatenating the channel feature vector including information on the feature map most related to whether there is the defect with another feature vector (for example, the spatial feature vector). Meanwhile, the Inception-CNN included in the encoder 42-1 or 42-2 has an advantage in capturing local patterns and complex features of an image, but has a problem of not accurately identifying very small defects. On the other hand, the SCA module has the advantage of being able to accurately identify very small defects, but has the disadvantage of requiring an initial feature map in which the features of the image are well extracted. Therefore, the computing device 100 may utilize a structure incorporating the Inception-CNN and SCA modules for the encoder 42-1 or 42-2 in the process of performing defect inspection, thereby obtaining a technical effect of accurately identifying very small defects while capturing local patterns and complex features of an image, thereby increasing the accuracy of defect inspection. Meanwhile, technical effects of the exemplary embodiments of the present disclosure are described in Table 1 below.

TABLE 1
Performance comparison table of various vision encoder CNN
models with examples (ours) of the present disclosure

| | | Number of | |
|---|---|---|---|
| Models | Accuracy | Parameters | Inference Time (ms) |
| Baseline CNN | 89.56% | 4,649,090 | 25.86 |
| Baseline CNN | 96.67% | 5,725,320 | 28.35 |
| with SCA | | | |
| Inception-CNN | 97.33% | 6,286,978 | 35.49 |
| ResNet50 | 98.75% | 25,204,738 | 112.53 |
| Inception-CNN | 99.33% | 7,304,706 | 37.2 |
| with SCA (ours) | | | |

Referring to Table 1 above, an exemplary embodiment of the present disclosure, which includes an Inception-CNN and an SCA module, shows 7.11% improved accuracy compared to an existing Baseline CNN, and 2% improved accuracy compared to a network using the Inception-CNN as a single.

In addition, ResNet50 achieves the highest accuracy of 98.75%, but is lower than the accuracy of the exemplary embodiment of the present disclosure, which is 99.33%, and it can be seen that the inference time is about 9 fps longer than the exemplary embodiment of the present disclosure due to the increase in complexity. Therefore, the exemplary embodiment of the present disclosure can achieve higher accuracy (99.33%) than the existing methods, while maintaining the inference time relatively fast at 37.2 ms, thereby obtaining a technical effect of achieving a balance between high accuracy and efficient processing.

Disclosed is a computer readable medium storing the data structure according to an exemplary embodiment of the present disclosure.

The data structure may refer to the organization, management, and storage of data that enables efficient access to and modification of data. The data structure may refer to the organization of data for solving a specific problem (e.g., data search, data storage, data modification in the shortest time). The data structures may be defined as physical or logical relationships between data elements, designed to support specific data processing functions. The logical relationship between data elements may include a connection between data elements that the user defines. The physical relationship between data elements may include an actual relationship between data elements physically stored on a computer-readable storage medium (e.g., persistent storage device). The data structure may specifically include a set of data, a relationship between the data, a function which may be applied to the data, or instructions. Through an availably designed data structure, a computing device can perform operations while using the resources of the computing device to a minimum. Specifically, the computing device can increase the efficiency of operation, read, insert, delete, compare, exchange, and search through the availably designed data structure.

The data structure may be divided into a linear data structure and a non-linear data structure according to the type of data structure. The linear data structure may be a structure in which only one data is connected after one data. The linear data structure may include a list, a stack, a queue, and a deque. The list may mean a series of data sets in which an order exists internally. The list may include a linked list. The linked list may be a data structure in which data is connected in a scheme in which each data is linked in a row with a pointer. In the linked list, the pointer may include link information with next or previous data. The linked list may be represented as a single linked list, a double linked list, or a circular linked list depending on the type. The stack may be a data listing structure with limited access to data. The stack may be a linear data structure that may process (e.g., insert or delete) data at only one end of the data structure. The data stored in the stack may be a data structure (LIFO-Last in First Out) in which the data is input last and output first. The queue is a data listing structure that may access data limitedly and unlike a stack, the queue may be a data structure (FIFO-First in First Out) in which late stored data is output late. The deque may be a data structure capable of processing data at both ends of the data structure.

The non-linear data structure may be a structure in which a plurality of data are connected after one data. The non-linear data structure may include a graph data structure. The graph data structure may be defined as a vertex and an edge, and the edge may include a line connecting two different vertices. The graph data structure may include a tree data structure. The tree data structure may be a data structure in which there is one path connecting two different vertices among a plurality of vertices included in the tree. That is, the tree data structure may be a data structure that does not form a loop in the graph data structure.

In the present disclosure, a network function, an artificial neural network, and a neural network may be used to be exchangeable. From here on, it will be described uniformly using neural networks.

The data structure may include the neural network. In addition, the data structures, including the neural network, may be stored in a computer readable medium. The data structure including the neural network may also include data preprocessed for processing by the neural network, data input to the neural network, weights of the neural network, hyper parameters of the neural network, data obtained from the neural network, an active function associated with each node or layer of the neural network, and a loss function for training the neural network. The data structure including the neural network may include predetermined components of the components disclosed above. In other words, the data structure including the neural network may include all of data preprocessed for processing by the neural network, data input to the neural network, weights of the neural network, hyper parameters of the neural network, data obtained from the neural network, an active function associated with each node or layer of the neural network, and a loss function for training the neural network or a combination thereof. In addition to the above-described configurations, the data structure including the neural network may include predetermined other information that determines the characteristics of the neural network. In addition, the data structure may include all types of data used or generated in the calculation process of the neural network, and is not limited to the above. The computer readable medium may include a computer readable recording medium and/or a computer readable transmission medium. The neural network may be generally constituted by an aggregate of calculation units which are mutually connected to each other, which may be called nodes. The nodes may also be called neurons. The neural network is configured to include one or more nodes.

The data structure may include data input into the neural network. The data structure including the data input into the neural network may be stored in the computer readable medium. The data input to the neural network may include training data input in a neural network training process and/or input data input to a neural network in which training is completed. The data input to the neural network may include preprocessed data and/or data to be preprocessed. The preprocessing may include a data processing process for inputting data into the neural network. Therefore, the data structure may include data to be preprocessed and data generated by preprocessing. The data structure is just an example and the present disclosure is not limited thereto.

The data structure may include the weight of the neural network (in the present disclosure, the weight and the parameter may be used as the same meaning). In addition, the data structures, including the weight of the neural network, may be stored in the computer readable medium. The neural network may include a plurality of weights. The weight may be variable and the weight is variable by a user or an algorithm in order for the neural network to perform a desired function. For example, when one or more input nodes are mutually connected to one output node by the respective links, the output node may determine a data value output from an output node based on values input in the input nodes connected with the output node and the weights set in the links corresponding to the respective input nodes. The data structure is just an example and the present disclosure is not limited thereto.

As a non-limiting example, the weight may include a weight which varies in the neural network training process and/or a weight in which neural network training is completed. The weight which varies in the neural network training process may include a weight at a time when a training cycle starts and/or a weight that varies during the training cycle. The weight in which the neural network training is completed may include a weight in which the training cycle is completed. Accordingly, the data structure including the weight of the neural network may include a data structure including the weight which varies in the neural network training process and/or the weight in which neural network training is completed. Accordingly, the above-described weight and/or a combination of each weight are included in a data structure including a weight of a neural network. The data structure is just an example and the present disclosure is not limited thereto.

The data structure including the weight of the neural network may be stored in the computer-readable storage medium (e.g., memory, hard disk) after a serialization process. Serialization may be a process of storing data structures on the same or different computing devices and later reconfiguring the data structure and converting the data structure to a form that may be used. The computing device may serialize the data structure to send and receive data over the network. The data structure including the weight of the serialized neural network may be reconfigured in the same computing device or another computing device through deserialization. The data structure including the weight of the neural network is not limited to the serialization. Furthermore, the data structure including the weight of the neural network may include a data structure (for example, B-Tree, Trie, m-way search tree, AVL tree, and Red-Black Tree in a nonlinear data structure) to increase the efficiency of operation while using resources of the computing device to a minimum. The above-described matter is just an example and the present disclosure is not limited thereto.

The data structure may include hyper-parameters of the neural network. In addition, the data structures, including the hyper-parameters of the neural network, may be stored in the computer readable medium. The hyper-parameter may be a variable which may be varied by the user. The hyper-parameter may include, for example, a learning rate, a cost function, the number of training cycle iterations, weight initialization (for example, setting a range of weight values to be subjected to weight initialization), and Hidden Unit number (e.g., the number of hidden layers and the number of nodes in the hidden layer). The data structure is just an example and the present disclosure is not limited thereto.

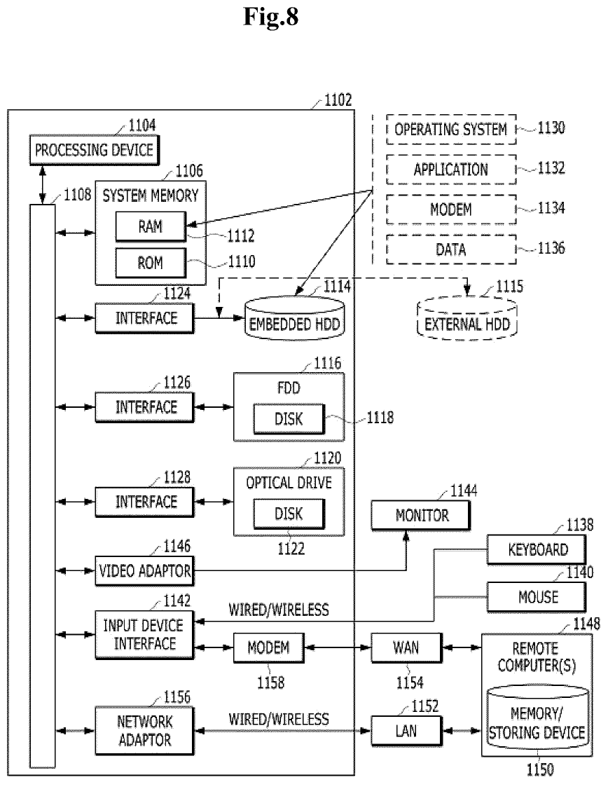

FIG. 8 is a normal and schematic view of an exemplary computing environment in which the exemplary embodiments of the present disclosure may be implemented.

It is described above that the present disclosure may be generally implemented by the computing device, but those skilled in the art will well know that the present disclosure may be implemented in association with a computer executable command which may be executed on one or more computers and/or in combination with other program modules and/or a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal obtained by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure. Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11(a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as software), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various exemplary embodiments presented herein may be implemented as manufactured articles using a method, a device, or a standard programming and/or engineering technique. The term manufactured article includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented exemplary embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be interpreted within the widest range which is coherent with the principles and new features presented herein.

What is claimed is:

1. A method for performing defect inspection using a neural network model, the method performed by one or more processors of a computing device, the method comprising:
obtaining multiple input data having different domains;
preprocessing first input data associated with a non-visual domain among the multiple input data;
obtaining first training data based on second input data associated with a visual domain among the multiple input data, and the preprocessed first input data; and
training a neural network model for performing defect inspection based on the first training data.

2. The method of claim 1, wherein the multiple input data having different domains include first input data associated with the non-visual domain and second input data associated with the visual domain, and
wherein the first input data associated with the non-visual domain includes time-series data.

3. The method of claim 2, wherein the first input data associated with the non-visual domain includes sensor data of a process.

4. The method of claim 3, wherein the sensor data of the process includes at least one of:
current sensor data;
voltage sensor data; or
gas flow sensor data.

5. The method of claim 1, wherein the preprocessing of the first input data associated with the non-visual domain among the multiple input data includes:
setting a time-series interval for the first input data; and
preprocessing the first input data based on the set time-series interval.

6. The method of claim 5, wherein the preprocessing of the first input data based on the set time-series interval includes:
transforming an interval included in the set time-series interval in the first input data into spectrogram data.

7. The method of claim 5, wherein the preprocessing of the first input data based on the set time-series interval further includes:
preprocessing second input data associated with the visual domain among the multiple input data.

8. The method of claim 7, wherein the preprocessing of the second input data associated with the visual domain among the multiple input data includes at least one of:
adjusting a size of the second input data associated with the visual domain;
performing normalization for the second input data; or
performing image augmentation for the second input data.

9. The method of claim 1, wherein the obtaining of the first training data based on the second input data associated with the visual domain among the multiple input data, and the preprocessed first input data includes:
obtaining a correct answer label corresponding to the preprocessed first input data and the second input data; and
obtaining the first training data based on the preprocessed first input data, the second input data, and the correct answer label.

10. The method of claim 1, wherein the training of the neural network model for performing the defect inspection based on the first training data includes:
obtaining a first feature by inputting the first input data included in the first training data into the neural network model, and obtaining a second feature by inputting the second input data included in the first training data into the neural network model;
performing defect inspection using the neural network model based on the first feature and the second feature; and
training the neural network model by comparing a result of the defect inspection with the first training data.

11. The method of claim 10, wherein the obtaining of the first feature by inputting the first input data included in the first training data into the neural network model includes:
obtaining first concatenated data based on first-first input data and first-second input data included in the first training data; and
obtaining the first feature by inputting the first concatenated data into the neural network model.

12. The method of claim 1, wherein the neural network model for performing the defect inspection includes an encoder for extracting a visual feature for input data.

13. The method of claim 12, wherein the encoder for extracting the visual feature includes at least one of:
extraction blocks for extracting features of different sizes for input data;
a first module for identifying a feature region related to a defect based on multiple features extracted from input data; or
a second module for identifying a feature related to the defect among the multiple features extracted for input data.

14. A computer program stored in a non-transitory computer-readable storage medium, wherein when the computer program is executed by one or more processors, the computer program allows the one or more processors to perform operations for performing defect inspection using a neural network model, the operations comprising:
an operation of obtaining multiple input data having different domains;
an operation of preprocessing first input data associated with a non-visual domain among the multiple input data;
an operation of obtaining first training data based on second input data associated with a visual domain among the multiple input data, and the preprocessed first input data; and
an operation of training a neural network model for performing defect inspection based on the first training data.

15. The computer program of claim 14, wherein the operation of preprocessing the first input data associated with the non-visual domain among the multiple input data includes:
an operation of setting a time-series interval for the first input data; and
an operation of preprocessing the first input data based on the set time-series interval.

16. The computer program of claim 15, wherein the operation of preprocessing the first input data based on the set time-series interval includes:
an operation of transforming an interval included in the set time-series interval in the first input data into spectrogram data.

17. The computer program of claim 15, wherein the operation of preprocessing the first input data based on the set time-series interval further includes:
an operation of preprocessing second input data associated with the visual domain among the multiple input data.

18. The computer program of claim 17, wherein the operation of preprocessing the second input data associated with the visual domain among the multiple input data includes at least one of:
an operation of adjusting a size of the second input data associated with the visual domain;
an operation of performing normalization for the second input data; or
an operation of performing image augmentation for the second input data.

19. The computer program of claim 14, wherein the operation of obtaining the first training data based on the second input data associated with the visual domain among the multiple input data, and the preprocessed first input data includes:
an operation of obtaining a correct answer label corresponding to the preprocessed first input data and the second input data; and
an operation of obtaining first training data based on the preprocessed first input data, the second input data, and the correct answer label.

20. A computing device comprising:
at least one processor; and
a memory,
wherein the at least one processor is configured to:
obtain multiple input data having different domains;
preprocess first input data associated with a non-visual domain among the multiple input data;
obtain first training data based on second input data associated with a visual domain among the multiple input data, and the preprocessed first input data; and
train a neural network model for performing defect inspection based on the first training data.
